(19) United States
(12) Patent Application Publication
(10) Pub. No.: US 2022/0009159 A1
(43) Pub. Date: Jan. 13, 2022

(54) ATTACHMENTS FOR OPTICAL SHAPING APPARATUS

(71) Applicant: TKR CORPORATION, Tokyo (JP)

(72) Inventors: Eiji OSHIMA, Tokyo (JP); Shunsuke NIREI, Tokyo (JP)

(21) Appl. No.: 17/328,867

(22) Filed: May 24, 2021

(30) Foreign Application Priority Data
May 22, 2020 (JP) 2020-089514

(51) Int. Cl. B29C 64/135; B29C 64/268; B29C 64/245

(52) U.S. Cl. CPC B29C 64/135; B33Y 10/00; B29C 64/245; B29C 64/268

(57) ABSTRACT

Provided is an attachment for stereolithography apparatuses capable of forming three-dimensional objects having various sizes. The attachment for stereolithography apparatuses includes a base mountable on and demountable from the formation table of a stereolithography apparatus and first and second support members mounted to the base. The base has a rectangular frame shape formed by guides and coupling rods. The first and second support members support a vat in positions in which the distance from an optical engine to the vat is longer than the distance from the optical engine to the formation table, such that the vat is approximately horizontal.

### TECHNICAL FIELD

The present invention relates to an attachment for stereolithography apparatuses that is mounted on a stereolithography apparatus that forms a desired three-dimensional object by solidifying a photocurable resin using a laser light source or the like.

### BACKGROUND ART

Attention is being paid to additive manufacturing technology, that is, 3D printers that aims at high-mix low-volume production, a reduction in the prototype production period, a reduction in the development cost, or the like. There are various object formation methods using a 3D printer. Among those, vat photopolymerization (stereolithography), which forms a three-dimensional object by selectively solidifying a photocurable resin using light, allows for formation of fine, high-resolution objects.

For example, a stereolithography apparatus described in U.S. Unexamined Patent Application Publication No. 2017/0291355 is known as a 3D printer employing stereolithography. The stereolithography apparatus of U.S. Unexamined Patent Application Publication No. 2017/0291355 uses Digital Light Processing® (DLP) as application means. Use of DLP as application means allows light corresponding to section data of a three-dimensional object to be applied at once.

See U.S. Unexamined Patent Application Publication No. 2017/0291355.

### SUMMARY OF INVENTION

Conventionally, development or prototyping of a product requires a time period of several months. Stereolithography allows a desired three-dimensional object to be formed in a short period of time. For this reason, the development period or prototyping period can be expected to be reduced significantly. On the other hand, the number of the types of formable three-dimensional objects have been increased as improvements in the accuracy with which stereolithography apparatuses form three-dimensional objects, and a demand has been raised to form protypes having various sizes in accordance with the specifications of various types of products in the product development/prototyping stage.

The size of an object formed by a stereolithography apparatus is determined by the light application range on the formation surface. By extending the distance from DLP to the formation surface in the stereolithography apparatus of U.S. Unexamined Patent Application Publication No. 2017/0291355, the projection range of DLP can be expanded but the projected image on the formation surface would be blurred. The stereolithography apparatus of U.S. Unexamined Patent Application Publication No. 2017/0291355 has difficulty in forming a high-resolution three-dimensional object.

An object of the present invention is to provide an attachment for stereolithography apparatuses capable of forming three-dimensional objects having various sizes. In particular, the present invention provides an attachment for stereolithography apparatuses capable of forming three-dimensional objects having various sizes using the features of a focus-free stereolithography apparatus.

An attachment for stereolithography apparatuses according to the present invention is mountable on and demountable from a stereolithography apparatus that forms a three-dimensional object by applying a light beam emitted from a light scanner to a photocurable resin in a vat through an opening of a formation table, and includes a base that is mountable on and demountable from the formation table and support means fixed to the base. The base has a rectangular frame shape having an opening through which a light beam from the light scanner passes. The support means supports the vat in a position in which a distance from the light scanner to the vat is longer than a distance from the light scanner to the formation table, such that the vat is approximately horizontal.

In the attachment for stereolithography apparatuses according to the present invention, the support means supports the vat in the position in which the distance from the light scanner to the vat is longer than the distance from the light scanner to the formation table, such that the vat is approximately horizontal. This means that the vat is located in a farther position than the formation table with respect to the light scanner. The light beam emitted from the light scanner passes through the opening of the base and is applied to the photocurable resin in the vat.

As described above, the size of a three-dimensional object formed by a stereolithography apparatus depends on the application range of a light beam applied to the formation surface. If the scan range of a light beam emitted from the light scanner is constant, the size of a three-dimensional object depends on the distance from the light scanner to the vat. According to the above configuration, the distance from the light scanner to the vat becomes longer than that of a conventional stereolithography apparatus. Thus, the scan range of the light beam on the formation surface of the photocurable resin stored in the vat is expanded, allowing for formation of a three-dimensional object having a larger size than a conventional one. Moreover, the base is detachable from the formation table. For this reason, by removing the attachment for stereolithography apparatuses according to the present invention from the formation table and directly fixing the vat to the formation table, as is done conventionally, or indirectly fixing the vat to the formation table through a jig or the like, a three-dimensional object having a smaller size than one when the attachment for stereolithography apparatuses is mounted on the formation table can be formed. As seen above, the attachment for stereolithography apparatuses according to the present invention allows for formation of three-dimensional objects having small-to-large various sizes.

In the attachment for stereolithography apparatuses configured described above, the base is preferably formed by coupling rectangular parallelepiped guides and coupling rods to each other.

In the attachment for stereolithography apparatuses according to the present invention, the base has the rectangular frame shape. Specific examples of the configuration of the base include a configuration in which rectangular parallelepiped guides and coupling rods are coupled to each other. By using the guides as portions that are mounted on and demounted from the formation table and fixing the guides to both ends of the coupling rods, a lightweight base with a simple configuration can be formed.

In the attachment for stereolithography apparatuses configured as described above, the support means preferably includes planar first and second support members, and the first and second support members preferably face each other with an opening of the base therebetween and are mounted to the base so as to be approximately vertical.

Since the vat is supported by the planar first and second support members, the weight of the support means is reduced while ensuring the path of the light beam emitted from the light scanner.

In the attachment for stereolithography apparatuses configured as described above, the first and second support members preferably each have a through hole that a part of the vat is fitted to and removed from.

By fitting the parts of the vat to the through holes formed in the first and second support members, the vat is supported in a position away from the formation table by a predetermined distance with a simple configuration. Also, by removing the parts of the vat from these through holes, the vat is removed from the attachment for stereolithography apparatuses.

Also, if the first and second support members of the attachment for stereolithography apparatuses configured as described above are formed of a flexible material, the parts of the vat can be fitted to the through holes of the first and second support members by bending one or both of the first and second support members. Note that even if only one of the first and second support members is formed of a flexible material, similar advantageous effects are obtained.

The attachment for stereolithography apparatuses configured as described above preferably further includes fixing rods. The fixing rods are preferably disposed between the first and second support members and fix the first and second support members in positions in which the fixing rods are opposed to the coupling rods with the through holes therebetween.

When the parts of the vat are supported by the through holes formed in the first and second support members, the position of the vat may vary with a vibration or the like during formation by the stereolithography apparatus, resulting in a reduction in the accuracy with which the three-dimensional object is formed. Since the fixing rods are extended between the first and second support members, the stiffness of the attachment for stereolithography apparatuses is improved. Also, since the fixing rods are extended between the first and second members in the positions in which the fixing rods are opposed to the coupling rods with the through openings therebetween, the vat is more reliably fixed, resulting in favorable suppression of a reduction in the accuracy with which the stereolithography apparatus forms three-dimensional objects.

The attachment for stereolithography apparatuses according to the present invention allows stereolithography apparatuses to form three-dimensional objects having various sizes.

### BRIEF DESCRIPTION OF DRAWINGS

FIG. 1 is a perspective view showing a stereolithography apparatus having a vat mounted thereon;

FIG. 2 is a side view of the vat guide of the stereolithography apparatus shown in FIG. 1;

FIG. 3 is a perspective view of the vat;

FIG. 4 is a perspective view schematically showing a method for mounting the vat on the stereolithography apparatus shown in FIG. 1;

FIG. 5 is a perspective view showing an attachment for stereolithography apparatuses according to the present embodiment;

FIG. 6 is a perspective view showing the attachment for stereolithography apparatuses according to the present embodiment;

FIG. 7 is a perspective view showing the stereolithography apparatus having the attachment for stereolithography apparatuses shown in FIG. 6 mounted thereon;

FIG. 8 is a plan view of the stereolithography apparatus shown in FIG. 7;

FIG. 9 is a sectional view taken along line A-A of the stereolithography apparatus shown in FIG. 8;

FIG. 10 is a sectional view taken along line A-A of the stereolithography apparatus shown in FIG. 8;

FIG. 11 is a sectional view taken along line A-A of the stereolithography apparatus shown in FIG. 8; and

FIG. 12 is a drawing schematically showing an optical path from a light scanner to the attachment for stereolithography apparatuses.

### DESCRIPTION of EMBODIMENTS

Now, an embodiment of the present invention will be described in detail with reference to the accompanying drawings.

An attachment for stereolithography apparatuses according to the present embodiment is assumed to be mounted on a stereolithography (vat photopolymerization) apparatus, which forms an object by selectively solidifying a photocurable resin using light, such as a laser light source.

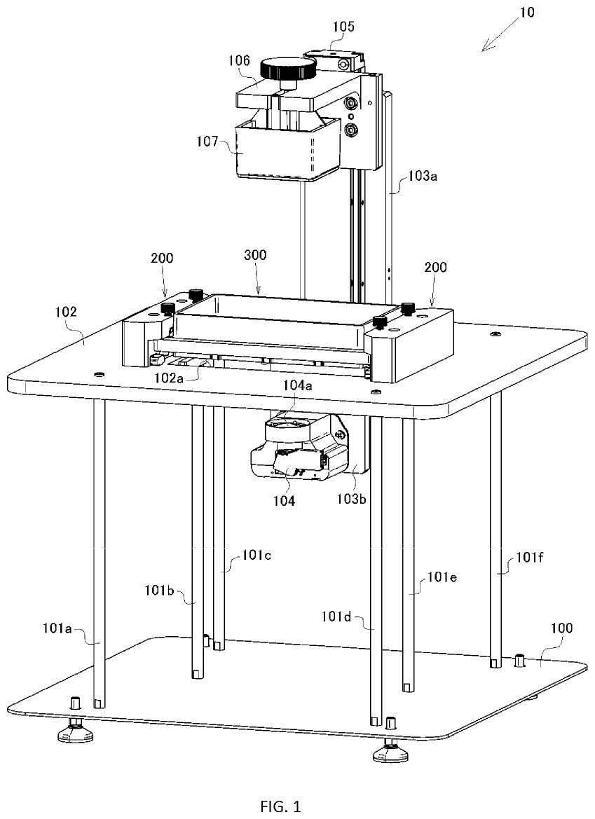

First, the basic configuration of the stereolithography apparatus will be described. As shown in FIG. 1, a stereolithography apparatus 10 includes a planar base 100, cylindrical formation table columns 101a, 101b, 101c, 101d, 101e, and 101f disposed so as to extend upward from the upper surface of the base 100, and a planar formation table 102 supported by the six columns 101a to 101f. The formation table 102 has approximately the same size as the base 100, and the periphery thereof is supported by the formation table columns 101a to 101f. Adjuster bolts (adjustment legs) are screwed to the four corners of the bottom surface of the base 100 so that the upper surface of the formation table 102 can be adjusted so as to be horizontal.

A rectangular opening 102a is disposed in the center of the formation table 102. A rectangular-parallelepiped column 103a is disposed in a standing manner near one long side of the rectangular opening 102a on the upper surface of the formation base 102 so as to extend vertically upward from the upper surface of the formation table 102. A column 103b is disposed in a protruding manner so as to extend vertically downward from the bottom surface of the formation table 102.

An optical engine 104 serving as an optical scanner is fixed to the column 103b through a bracket below the approximate center of the rectangular opening 102a of the formation table 102. The optical engine 104 includes a light source, such as a laser light source, optical elements, such as a reflection mirror and a collimate lens, and a two-dimensional MEMS (micro-electro-mechanical systems) mirror. A light beam emitted from the light source enters the two-dimensional MEMS mirror through the optical elements. The two-dimensional MEMS mirror is an electro-magnetically driven mirror and is rotatable in a two-dimensional direction. The light beam reflected by the two-dimensional MEMS mirror scans in accordance with the movement of the two-dimensional MEMS mirror. A condenser lens 104a is fixed between the optical engine 104 and formation table 102 using the same bracket as that of the optical engine 104.

A linear motion mechanism 105 is fixedly disposed on the surface near the rectangular opening 102a of the column 103a along the column 103a. The linear motion mechanism 105 includes a slide member and moves the slide member in the vertical direction (up-down direction) using the driving force of a motor. An inverted L-shaped bracket 106 is fixed to the slide member.

A standard platform 107 is hung on the bracket 106. The standard platform 107 includes a body having an approximately rectangular parallelepiped shape and a hanging portion that protrudes upward. The standard platform 107 is hung on the bracket 106 by fixing the hanging portion of the standard platform 107 to the protruding portion of the bracket 106 using a screw. The standard platform 107 is integrally fixed to the slide member of the linear motion mechanism 105 through the bracket 106 and is moved in the up-down direction by driving the linear motion mechanism 105.

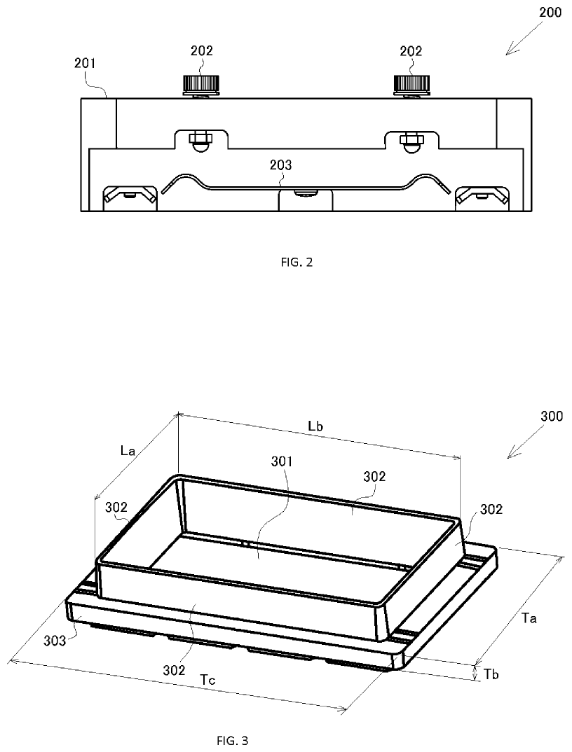

A vat guide 200 is placed on the formation table 102 such that the short sides of the opening 102a are sandwiched between portions of the vat guide 200. As shown in FIG. 2, the vat guide 200 includes a guide body 201, adjustment screws 202, and a leaf spring 203. The guide body 201 is an inverted L-shaped block. Two screw holes to which the adjustment screws 202 can be screwed are formed in apprentice-shaped protruding portions of the guide body 201 so as to vertically penetrate the protruding portions. The tips of the adjustment screws 202 are in the shape of a semi-sphere. The belt-shaped leaf spring 203 is disposed in a position opposite to the tips of the adjustment screws 202. Protrusions protruding toward the adjustment screws 202 are disposed on both ends of the leaf spring 203.

A vat 300 is inserted into and removed from the vat guide 200. The material of a three-dimensional object is stored in the vat 300. The material is a photocurable resin, and typical examples include ultraviolet curable resins such as acrylic resin (polymer acrylate) and urethane resin (urethane acrylate).

As shown in FIG. 3, the vat 300 is a container that is partially opened and formed of a transparent material, and is structured such that the amount of stored photocurable resin can be easily checked. The vat 300 includes a rectangular bottom portion 301 and a side portion 302 disposed in a standing manner so as to surround the periphery of the bottom portion 301. A collar 303 is disposed on the bottom of the side portion 302 so as to surround the side portion 302. The collar 303 is formed such that the length Ta in the short-side direction thereof becomes longer than the length La in the short-side direction of the side portion 302 and the length Tc in the long-side direction thereof becomes longer than the length Lb in the long-side direction of the side portion 302. The thickness Tb of the collar 303 is slightly greater than the distance between the tips of the adjustment screws 202 and the protrusions of the leaf spring 203 in the vat guide 200.

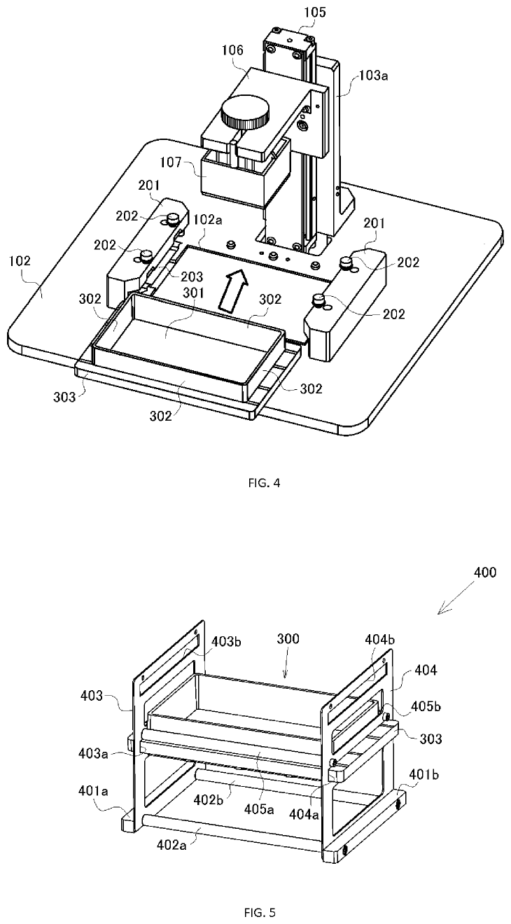

To mount the vat 300 on the stereolithography apparatus, first, the collar 303 of the vat 300 is inserted between the tips of the adjustment screws 202 and the leaf spring 203 in the vat guide 200, as shown in FIG. 4. Then, with the vat 300 inserted, the adjustment screws 202 are tightened so that the vat 300 is sandwiched between the portions of the vat guide 200. That is, the vat 300 is fixed to the formation table 102 through the vat guide 200. Hereafter, the state in which the vat 300 is directly fixed to the formation table 102 through the vat guide 200 as described above is referred to as the “standard state.”

To form a three-dimensional object, first, the standard platform 107 is lowered so that the standard platform 107 is immersed in the photocurable resin in the vat 300. Then, light emitted from the optical engine 104 is applied to the bottom surface (formation surface) of the standard platform 107 through the condenser lens 104a. Thus, the photocurable resin between the bottom portion 301 of the vat 300 and the formation surface of the standard platform 107 is solidified. Then, the standard platform 107 is raised at a predetermined pitch so that the photocurable resin flows in under the solidified layer. By repeating the above series of steps, the three-dimensional object is formed.

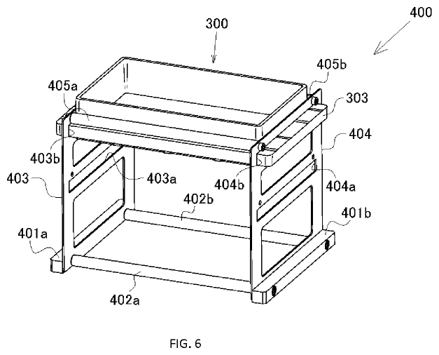

Next, the attachment for stereolithography apparatuses according to the present embodiment will be described. By mounting the attachment for stereolithography apparatuses according to the present embodiment on the stereolithography apparatus, a larger three-dimensional object than one formed in the standard state can be formed. Hereafter, an attachment for stereolithography apparatuses capable of forming two three-dimensional objects having different sizes will be described with reference to FIGS. 5 and 6.

An attachment 400 for stereolithography apparatuses according to the present embodiment changes the distance from the optical engine 104 to the vat 300. Thus, the size of a three-dimensional object to be formed is changed. For convenience, a three-dimensional object formed in the standard state is referred to as the small-size three-dimensional object, and three-dimensional objects formed by mounting the attachment 400 for stereolithography apparatuses as the medium-size and large-size three-dimensional objects. FIG. 5 is a perspective view showing a state in which the vat 300 is mounted in a position for forming the medium-size three-dimensional object in the attachment 400 for stereolithography apparatuses. On the other hand, FIG. 6 is a perspective view showing a state in which the vat 300 is mounted in a position for forming the large-size three-dimensional object in the attachment 400 for stereolithography apparatuses.

The attachment 400 for stereolithography apparatuses includes a base that is mountable on and demountable from the formation table 102 through the vat guide 200 and support means that supports the vat 300 in a predetermined position. The support means is fixed to the base.

The base has a rectangular frame shape. Light emitted from the optical engine 104 passes through an opening in the center of the base. The base has a rectangular frame shape formed by coupling approximately rectangular parallelepiped guides 401a and 401b and coupling rods 402a and 402b to each other. The guides 401a and 401b are disposed in parallel, and the ends thereof are coupled to each other by the two coupling rods 402a and 402b, which are also disposed in parallel. In the present embodiment, a rectangular space surrounded by the guide 401a, coupling rod 402b, guide 401b, and coupling rod 402a corresponds to the opening.

The coupling rods 402a and 402b are solid rods having circular cross-sectional shapes. The axial length of the coupling rods 402a and 402b is approximately the same as the length Lb of the vat 300. Note that the coupling rods 402a and 402b need not be solid rods having circular cross-sectional shapes and may be, for example, solid rods having oval cross-sectional shapes, or polygonal cross-sectional shapes, such as triangular or rectangular shapes. Also, the coupling rods 402a and 402b need not be solid rods and may be hollow rods.

The guides 401a and 401b are portions used to insert the base into the vat guide 200 and remove it therefrom. The height (thickness) of the guides 401a and 401b is approximately the same as the thickness Tb of the collar 303 of the vat 300. The width of the guides 401a and 401b, that is, the length thereof along the axial direction of the coupling rods 402a and 402b is determined such that the length along the above axial direction from the outer side surface of the guide 401a to the outer side surface of the guide 401b becomes approximately the same as the length Tc of the collar 303 of the vat 300.

Due to the guides 401a and 401b thus shaped, the width of the base becomes approximately the same as the length Tc of the collar 303 of the vat 300 and the thickness of both ends of the base becomes approximately the same as the thickness Tb of the collar 303 of the vat 300. This makes the base mountable on and demountable from the formation table 102. Specifically, the base is mounted on the formation table 102 by inserting the guides 401a and 401b of the base into the vat guide 200. Conversely, the base is demounted from the formation table 102 by removing the guides 401a and 401b of the base from the vat guide 200.

The support means includes a tabular first support member 403 and a tabular second support member 404. The first support member 403 and second support member 404 are disposed in a standing manner so as to face each other such that the short sides of the opening of the base are sandwiched therebetween, as well as are mounted to the guides 401a and 401b of the base so as to be approximately vertical. The first support member 403 and second support member 404 are formed of a flexible material.

Two through holes, vat support holes 403a and 403b, are disposed in the first support member 403 so as to be in parallel in the upward direction. The vat support hole 403b is formed near the end of the first support member 403. The vat support hole 403a is formed near an intermediate position between the base and end of the first support member 403. Similarly, two through holes, vat support holes 404a and 404b, are disposed in the second support member 404 so as to be in parallel in the upward direction. The vat support hole 404b is formed near the end of the second support member 404, and the vat support hole 404a is formed near an intermediate position between the base and end of the second support member 404. The shapes and formation positions in the horizontal direction of the vat support holes 403a and 403b of the first support member 403 and the vat support holes 404a and 404b of the second support member 404 match each other.

The vat support holes 403a, 403b, 404a, and 404b (hereafter referred to as the “vat support holes 403a to 404b”) are formed such that parts of the collar 303 of the vat 300 can be fitted thereto and removed therefrom. Specifically, the vat support holes 403a to 404b are rectangular through holes, the width thereof is approximately the same as the length Ta of the collar 303 of the vat 300, and the height thereof is approximately the same as the thickness Tb of the collar 303 of the vat 300. The vat support holes 403a to 404b are disposed in the first support member 403 and second support member 404 with the long sides thereof being horizontal. By inserting the collar 303 of the vat 300 into the vat support holes 403a and 404a, or 403b and 404b, the vat 300 is supported in a position in which the distance from the optical engine 104 to the vat 300 is longer than the distance from the optical engine 104 to the formation table 102, so as to be approximately horizontal.

Fixing rods 405a and 405b are disposed between the first support member 403 and second support member 404. The axial length of the fixing rods 405a and 405b is approximately the same as the length Lb of the vat 300. The fixing rod 405a and fixing rod 405b are disposed in parallel at a slightly wider interval than the length La of the vat 300. The fixing rods 405a and 405b are extended between the first support member 403 and second support member 404 in the vicinities of the vat support holes 403a to 404b and, more specifically, in positions opposite to the coupling rods 402a and 402b with the vat support holes 403a to 404b therebetween.

The positions in which the fixing rods 405a and 405b are extended between the first support member 403 and second support member 404 depend on the position in which the vat 300 is supported. When the vat 300 is supported by the vat support holes 403a and 404a (hereafter referred to as the “first-stage vat support holes”), the fixing rods 405a and 405b are extended between the first support member 403 and second support member 404 over the vat support holes 403a and 404a such that the outside of the side portion 302 of the vat 300 serving as a container is sandwiched between the fixing rods 405a and 405b. On the other hand, when the vat 300 is supported by the vat support holes 403b and 404b (hereafter referred to as the “second-stage vat support holes”), the fixing rods 405a and 405b are extended between the first support member 403 and second support member 404 over the vat support holes 403b and 404b such that the outside of the side portion 302 of the vat 300 serving as a container is sandwiched between the fixing rods 405a and 405b. By extending the fixing rods 405a and 405b between the first support member 403 and second support member 404 in the positions closer to the ends over the vat support holes 403a to 404b as described above, the stiffness of the attachment 400 for stereolithography apparatuses is improved. In the present embodiment, both ends of the fixing rods 405a and 405b and 405b are fixed to the first support member 403 and second support member 404 using screws.

When forming the medium-size three-dimensional object, the collar 303 of the vat 300 is inserted into the first-stage vat support holes, as shown in FIG. 5. On the other hand, when forming the large-size three-dimensional object, the collar 303 of the vat 300 is inserted into the second-stage vat support holes, as shown in FIG. 6. As described above, the first support member 403 and second support member 404 are formed of a flexible material. For this reason, by bending the first support member 403 and second support member 404, the collar 303 of the vat 300 is sandwiched therebetween and thus the vat 300 is supported thereby. For example, the collar 303 of the vat 300 is inserted into the vat support hole 404a by bending the upper end of the first support member 403 outward; and then, the collar 303 of the vat 300 is inserted into the vat support hole 403a while releasing the force applied to the upper end of the first support member 403. Thus, the vat 300 is supported by the first-stage vat support holes.

Since the vat 300 is supported by the first-stage vat support holes, the distance from the optical engine 140 to the vat 300 is longer than the distance from the optical engine 104 to the formation table 102. Also, when the vat 300 is supported by the second-stage vat support holes, the distance from the optical engine 140 to the vat 300 becomes longer than that when the vat 300 is supported by the first-stage vat support holes.

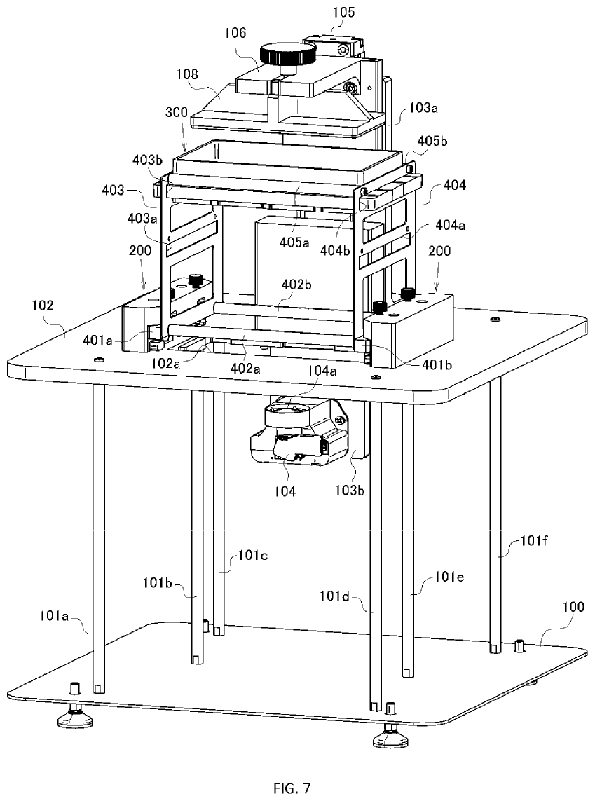

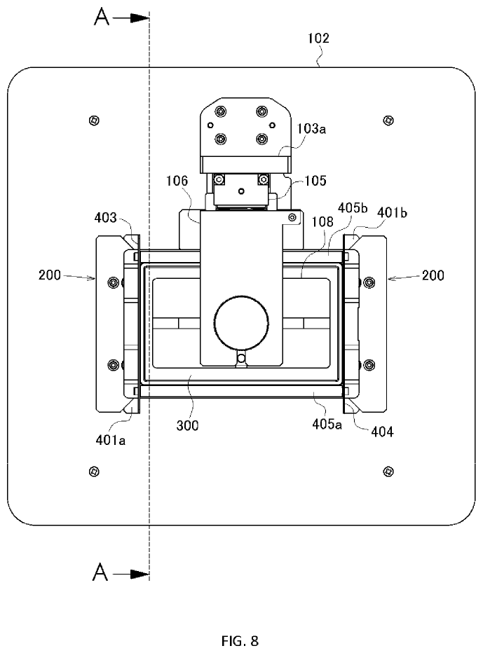

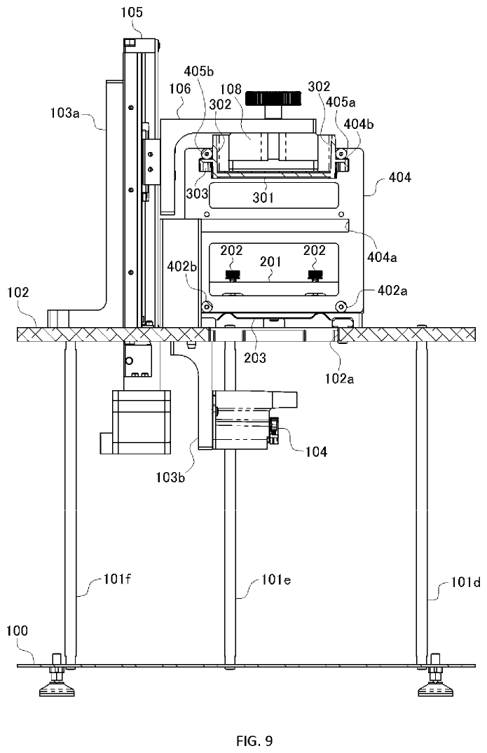

A mechanism that is able to form a three-dimensional object having a larger size than a conventional one by mounting the attachment for stereolithography apparatuses according to the present embodiment on the stereolithography apparatus will be described using an example in which the large-size three-dimensional object is formed. To form the large-size three-dimensional object, an extended platform 108 one size larger than the standard platform 107 is mounted on the bracket 106 in place of the standard platform 107 in the stereolithography apparatus according to the present embodiment, as shown in FIGS. 7 and 8.

When forming the large-size three-dimensional object, the collar 303 of the vat 300 is inserted into the second-stage vat support holes, as shown in FIG. 6, and the fixing rods 405a and 405b are fixed over the ends of the second-stage vat support holes using screws. Then, as shown in FIGS. 7 and 8, the attachment 400 for stereolithography apparatuses is mounted on the formation table 102 by inserting the guides 401a and 401b of the attachment 400 for stereolithography apparatuses into the vat guide 200. Note that, in the present embodiment, the first support member 403 and second support member 404 are formed of a flexible material and therefore the collar 303 of the vat 300 can be inserted into the second-stage vat support holes even after the attachment 400 for stereolithography apparatuses is mounted on the formation table 102.

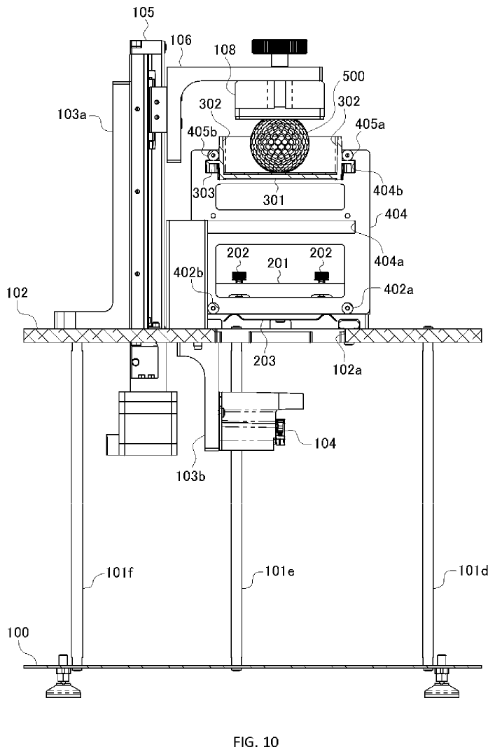

Subsequently, the extended platform 108 is immersed in the photocurable resin in the vat 300. Then, light is emitted from the optical engine 104 with the extended platform 108 immersed in the photocurable resin in the vat 300 and is applied to the bottom surface (formation surface) of the extended platform 108 through the condenser lens 104a. Thus, the photocurable resin between the bottom portion 301 of the vat 300 and the formation surface of the extended platform 108 is solidified. Then, the extended platform 108 is raised at a predetermined pitch so that the photocurable resin newly flows in below the solidified layer. By repeating the above series of steps, the large-size three-dimensional object is formed as a three-dimensional object 500, as shown in FIG. 10.

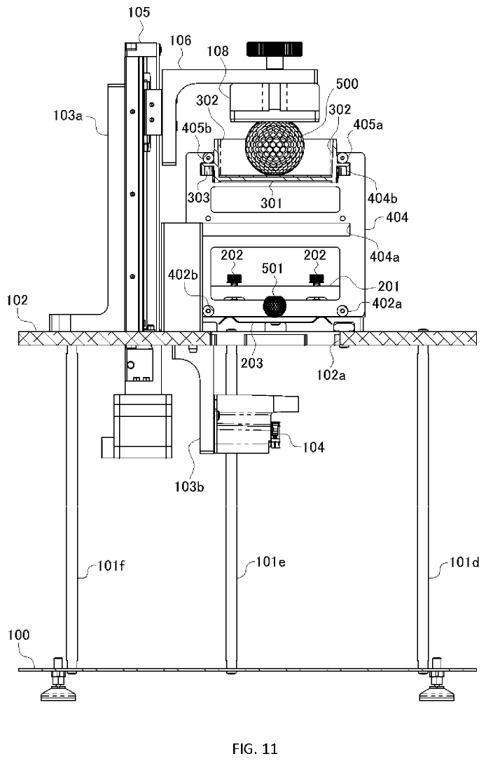

FIG. 11 shows the large-size three-dimensional object 500, as well as a small-size three-dimensional object 501 formed in the standard state. As shown in FIG. 11, even if the scan range of the optical engine 104 is the same, the three-dimensional object having a larger size than that formed by directly fixing the vat 300 to the formation table 102 can be formed by mounting the attachment 400 for stereolithography apparatuses.

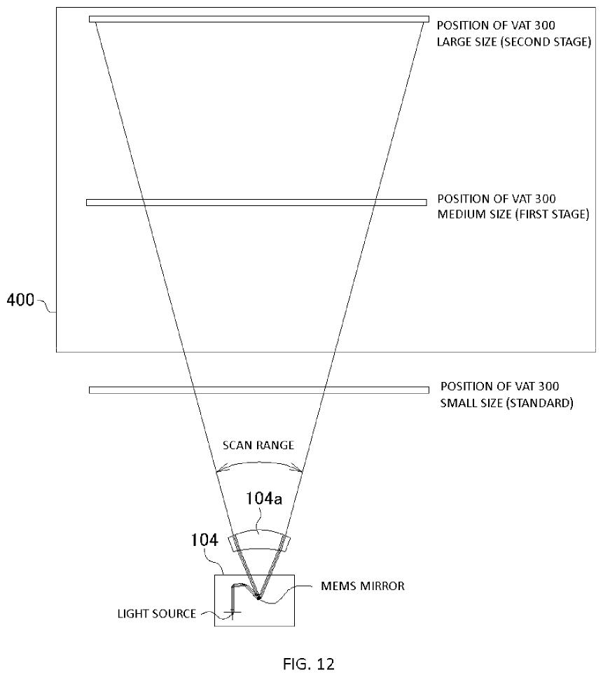

While the example in which the large-size three-dimensional object is formed has been described above, a three-dimensional object having a size different from this three-dimensional object can be formed by using the first-stage vat support holes. If the scan range of a light beam emitted from the optical engine 104 is constant, as shown in FIG. 12, the size of a formable three-dimensional object depends on the distance from the optical engine 104 to the vat 300. By inserting the collar 303 of the vat 300 into the first-stage vat support holes, the medium-size three-dimensional object, that is, a three-dimensional object having a size between those of the three-dimensional object 500 (large size) and the three-dimensional object 501 (small size) can be formed. As seen above, the attachment 400 for stereolithography apparatuses according to the present embodiment allows the three sizes of three-dimensional objects, that is, the large-size, medium-size, and small-size three-dimensional objects to be formed.

The attachment for stereolithography apparatuses according to the present invention is not limited to the above embodiment. By disposing multiple vat support holes, three-dimensional objects having various sizes can be formed. For example, by extending the first support member 403 and second support member 404 upward and disposing vat support holes above the vat support holes 403b and 404b, a three-dimensional object having a larger size than the three-dimensional object 500 can be formed.

While, in the above embodiment, the base is formed by coupling the guides 401a and 401b and the coupling rods 402a and 402b to each other, the base need not be formed as in the above embodiment. For example, the base may be formed by forming an opening in the approximate center of a rectangular flat plate. Preferably, the size of the opening is determined on the basis of the area of an opening through which a light beam from the optical engine 104 passes. As long as the thickness of the flat plate is approximately the same as the thickness Tb of the collar 303 of the vat guide 200 and the width of the flat plate is approximately the same as the length Tc of the collar 303 of the vat 300, the base is inserted into the vat guide 200 and thus the attachment for stereolithography apparatuses is mounted on the formation table 102.

The support means may have any configuration as long as it is able to support the vat. For example, the support means may consist of a rectangular prism whose central portion is open in the up-down direction and whose internal dimensions are approximately the same as the dimensions of the opening of the base. Even the support means having thus configured is able to support the vat by placing the vat on the upper end surface of the rectangular prism. Also, the support means may be configured to move the vat continuously in the up-down direction by driving a motor. To sum up, the support means may have any configuration as long as it is able to support the vat in a position in which the distance from the light scanner to the vat is longer than the distance from the light scanner to the formation table.

The method for mounting and demounting the attachment for stereolithography apparatuses on and from the formation table of the stereolithography apparatus is not limited to the method according to the above embodiment, that is, the mounting/demounting method using the vat guide 200. For example, if the formation table of the stereolithography apparatus is formed of a ferromagnetic metal or the like, a magnet may be previously disposed on the formation-surface side of the base so that the attachment for stereolithography apparatuses is mounted and demounted on and from the formation table by the force of this magnet. Also, screw holes may be formed in the formation table so that the attachment for stereolithography apparatuses is mounted and demounted on and from the formation table by screwing screws into the screw holes.

As described above, use of the attachment for stereolithography apparatuses according to the above embodiment in the stereolithography apparatus allows for formation of three-dimensional objects having various sizes.

The present invention is applicable as an attachment mounted on stereolithography apparatuses to form three-dimensional objects having various sizes.

1. An attachment for stereolithography apparatuses that is mountable on and demountable from a stereolithography apparatus that forms a three-dimensional object by applying a light beam emitted from a light scanner to a photocurable resin in a vat through an opening of a formation table, the attachment comprising:
a base that is mountable on and demountable from the formation table; and
support means fixed to the base, wherein
the base has a rectangular frame shape having an opening through which a light beam from the light scanner passes, and the support means supports the vat in a position in which a distance from the light scanner to the vat is longer than a distance from the light scanner to the formation table, such that the vat is approximately horizontal.

2. The attachment for stereolithography apparatuses of claim 1, wherein the base is formed by coupling rectangular parallelepiped guides and coupling rods to each other.

3. The attachment for stereolithography apparatuses of claim 2, wherein
the support means comprises planar first and second support members, and
the first and second support members face each other with an opening of the base therebetween and are mounted to the base so as to be approximately vertical.

4. The attachment for stereolithography apparatuses of claim 3, wherein the first and second support members each have a through hole that a part of the vat is fitted to and removed from.

5. The attachment for stereolithography apparatuses of claim 3, wherein the first and second support members are formed of a flexible material.

6. The attachment for stereolithography apparatuses of claim 4, further comprising fixing rods, wherein
the fixing rods are extended between the first and second support members in positions in which the fixing rods are opposed to the coupling rods with the through holes therebetween.

7. The attachment for stereolithography apparatuses of claim 4, wherein the first and second support members are formed of a flexible material.

8. The attachment for stereolithography apparatuses of claim 5, further comprising fixing rods, wherein
the fixing rods are extended between the first and second support members in positions in which the fixing rods are opposed to the coupling rods with the through holes therebetween.
